(19) United States
(12) Patent Application Publication
(10) Pub. No.: US 2018/0251059 A1
(43) Pub. Date: Sep. 6, 2018

(54) VEHICLE CUP HOLDER ASSEMBLY

(71) Applicant: CALSONIC KANSEI NORTH AMERICA, INC., Farmington Hills, MI (US)

(72) Inventor: Marius Cociuba, Dearborn, MI (US)

(21) Appl. No.: 15/447,322

(22) Filed: Mar. 2, 2017

(51) Int. Cl. B60N 3/10; A47G 23/02

(52) U.S. Cl. CPC B60N 3/108; A47G 23/0241; A47G 23/0208

(57) ABSTRACT

A retainer assembly for a cup holder includes an arm defining an first axis and a second axis, the arm configured to pivot about an first axis, and a finger pivotally coupled to the arm about the second axis. The finger is configured to be received in the cup holder.

### BACKGROUND

The present application relates generally to the field of cup holders for use in vehicles or other applications.

Vehicle cup holders may include one or more cavities for retaining a beverage container, and each of the cavities may include one or more movable members (e.g., fingers) that move in response to insertion and/or removal of a beverage container from the cavity so as to help retain the beverage container within the cavity. The one or more members or fingers act to more securely hold the beverage container so that it will be less likely to move during operation of the vehicle.

One challenge associated with conventional cup holders relates to the interaction between the movable members and the beverage container. Where the beverage container has a relatively straight-sided profile, the beverage container may be relatively easily inserted into and removed from the cavity of the cup holder. However, beverage containers having more complicated geometries, such as an inwardly-curved profile (e.g., as may be used with soda bottles and water bottles), may experience additional resistance from the movable members during insertion or removal. For example, where the movable members are only hinged at a top of the movable member, the bottle may be inserted into the cup holder but experience significant resistance from the retention structure when being withdrawn therefrom. Such high resistance may increase the likelihood that the contents of the container may be spilled when the container is withdrawn from the cup holder.

It would be advantageous to provide an improved cup holder that includes a more robust design and which allows for more consistent resistance during insertion and removal of beverage containers.

### SUMMARY

One embodiment relates to a retainer assembly for a cup holder, including an arm defining an first axis and a second axis, the arm configured to pivot about the first axis, and a finger pivotally coupled to the arm about the second axis. The finger is configured to be received in the cup holder.

Another embodiment relates to a cup holder assembly, including a cup holder and a retainer assembly including an arm defining an upper axis and a lower axis, the arm configured to pivot about an upper axis, and a finger pivotally coupled to the arm about the lower axis. The finger is configured to be received in the cup holder.

### BRIEF DESCRIPTION OF THE DRAWINGS

FIG. 1 is a top, front perspective view of a cup holder assembly, according to an exemplary embodiment.

FIG. 2 is a top, front perspective view of a retainer assembly, according to an exemplary embodiment.

FIG. 3 is an exploded view of the retainer assembly of FIG. 2.

FIG. 4A is a rear elevation view of the retainer assembly of FIG. 2.

FIG. 4B is a front elevation view of the retainer assembly of FIG. 2.

FIG. 5 is a top, front perspective view of a case and an arm, according to an exemplary embodiment.

FIG. 6 is a top, rear perspective view of a finger, according to an exemplary embodiment.

FIG. 7 is a side elevation view of the finger of FIG. 6 installed on an arm, according to an exemplary embodiment.

FIG. 8A is a cross-sectional view of a cup holder assembly, showing a container being inserted into a cup holder, according to an exemplary embodiment.

FIG. 8B shows the container of FIG. 8A further inserted into the cup holder.

FIG. 8C shows the container of FIGS. 8A and 8B further inserted into the cup holder.

FIG. 9A is a cross-sectional view of a cup holder assembly, showing a container being withdrawn from a cup holder, according to an exemplary embodiment.

FIG. 9B shows the container of FIG. 9A further withdrawn from the cup holder.

FIG. 9C shows the container of FIGS. 9A and 9B further withdrawn from the cup holder.

### DETAILED DESCRIPTION

Referring to the FIGURES generally, a cup holder assembly for a vehicle is shown according to an exemplary embodiment, and includes a plurality of cup holders, each of which includes one or move movable retention members for securing contents within the cup holders (such movable retention members will hereinafter be referred to as “retainer assemblies”). Each retainer assembly includes a housing, a first movable portion (referred to hereinafter as an “arm”), and a second movable portion (referred to hereinafter as a “finger”). The arm and finger are configured to move relative to the housing to reduce the resistance for inserting and withdrawing a container from the cup holder while still providing secure retention of the container when the container is positioned within the cup holder.

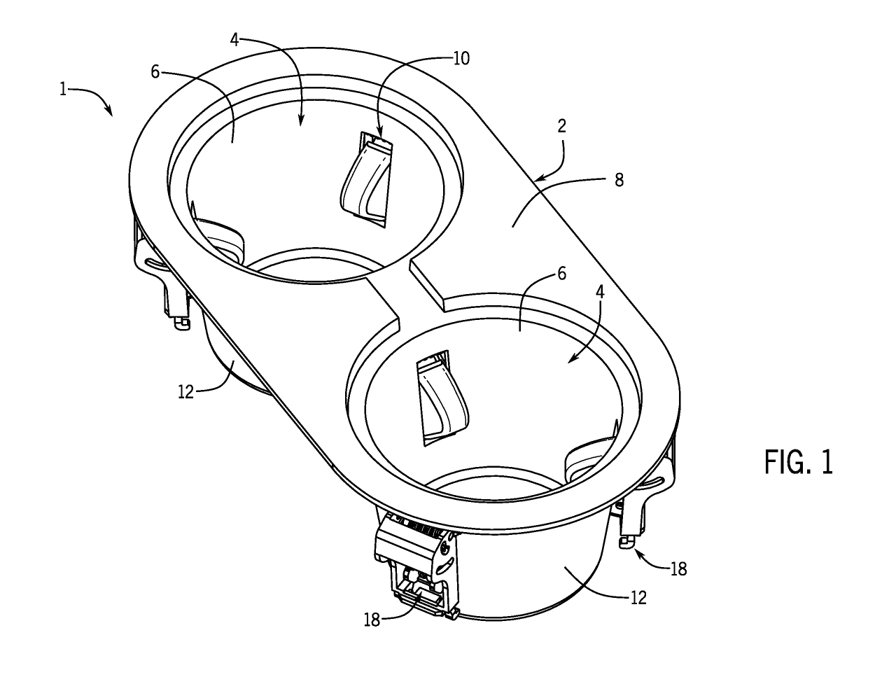

Referring to FIG. 1, a cup holder assembly 1 is shown according to an exemplary embodiment. The cup holder assembly 1 includes a body 2 that defines two cup holders 4 having walls 6 extending downward from an upper surface 8 of the body 2. Each cup holder 4 is configured to receive a beverage container (or other type of container or object) therein. While FIG. 1 shows the body 2 as defining two cup holders 4, according to other exemplary embodiments, more or fewer cup holders 4 may be included.

As shown in FIG. 1, a plurality of retainer assemblies 18 are disposed about each cup holder 4. A plurality of vertically-elongate slots 10 extend through the wall 6 and are configured to receive at least a portion of the retainer assembly 18 therethrough. For example, the wall 6 may define three slots 10 distributed evenly (e.g., spaced apart by approximately 120 degrees between adjacent retainer assemblies 18) at an outer periphery of the cup holder 4. Each slot 10 is configured to receive a corresponding retainer assembly 18. While FIG. 1 shows each cup holder 4 having three slots 10 and three retainer assemblies 18, according to other exemplary embodiments, a cup holder 4 may include more or fewer slots 10 and retainer assemblies 18.

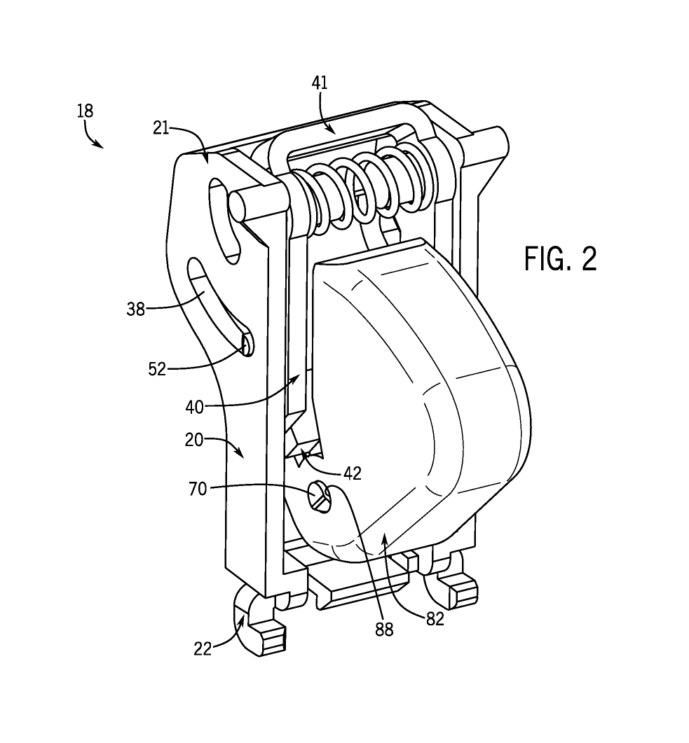

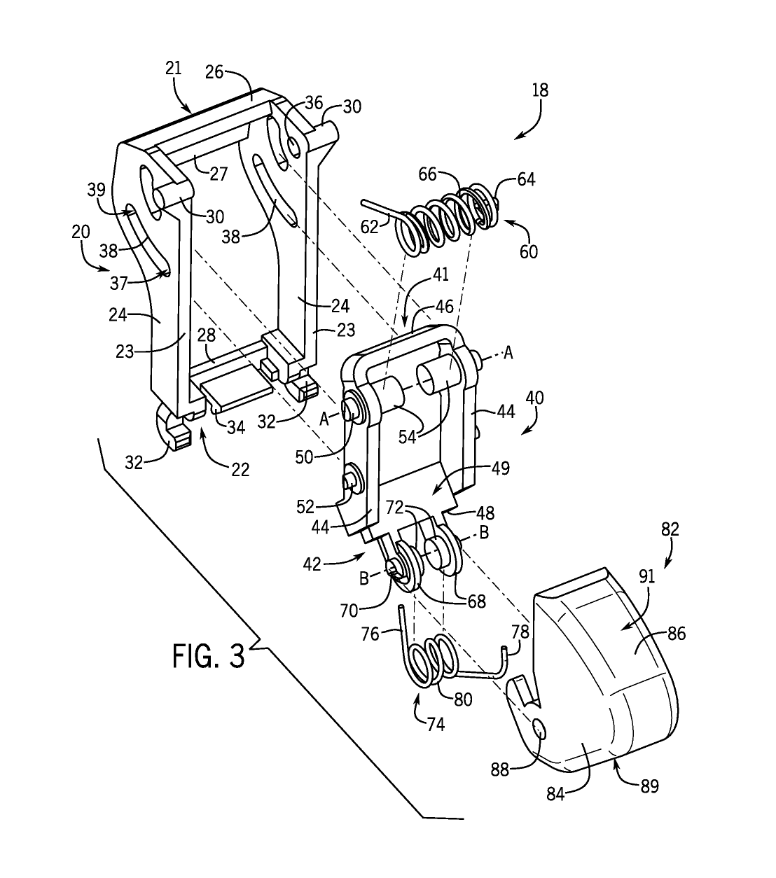

Referring now to FIGS. 2 and 3, a retainer assembly 18 is shown according to an exemplary embodiment. The retainer assembly 18 includes a housing 20 configured to be coupled to an outer surface 12 of the wall 6 (e.g., external to the cup holder 4 and concealed within a vehicle center console). An arm 40 is pivotally coupled to the housing 20 proximate an upper end 21 of the housing 20. A finger 82 is pivotally coupled to the arm 40 proximate a lower end 42 of the arm 40.

Referring to FIGS. 3-5, the housing 20 and other components of the retainer assembly 18 are shown according to an exemplary embodiment. The housing 20 includes a pair of opposing housing walls 24 (i.e., sides) extending generally vertically. The housing walls 24 include inner surfaces 25 having an inner housing width W₁ defined therebetween. A housing upper cross member 26 extends between the housing walls 24 proximate an upper end 21 of the housing 20 and a housing lower cross member 28 extend between the housing walls 24 proximate a lower end 22 of the housing 20. An upper guide 30 extends laterally outward from each the housing wall 24 at the upper end 21 of the housing 20. The upper guides 30 are configured to engage the outer surface 12 of the wall 6 to hold the housing 20 in a fixed vertical position relative to the body 2. For example, the outer surface 12 of the wall 6 may define grooves corresponding to and configured to receive the upper guides 30, such that a forward edge 23 of the housing 20 is configured to engage the outer surface 12. While FIG. 3 shows the housing 20 having upper guides 30, according to other exemplary embodiments, the upper end 21 of the housing 20 may be coupled to the outer surface 12 in other ways. According to yet another exemplary embodiment, the housing 20 may be integrally formed with the cup holder 4.

A lower guide 32 extends from each of the housing walls 24 proximate the lower end 22 of the housing 20. The lower guides 32 extend from the housing walls 24 toward the forward edge 23 of the housing 20 and are configured to engage corresponding recesses defined by the outer surface 12. A catch 34 extends from the housing lower cross member 28 toward the forward edge 23 of the housing 20 and is configured to engage a corresponding structure defined by the outer surface 12 with an interference fit. For example, the upper guides 30 and/or the lower guides 32 may interact with the outer surface 12 to hold the housing 20 in a fixed vertical position, such that the catch 34 may not be disengaged from the outer surface 12 without applying an outside force to deflect the catch 34. According to other exemplary embodiments, the housing 20 may be coupled to the outer surface 12 in other ways.

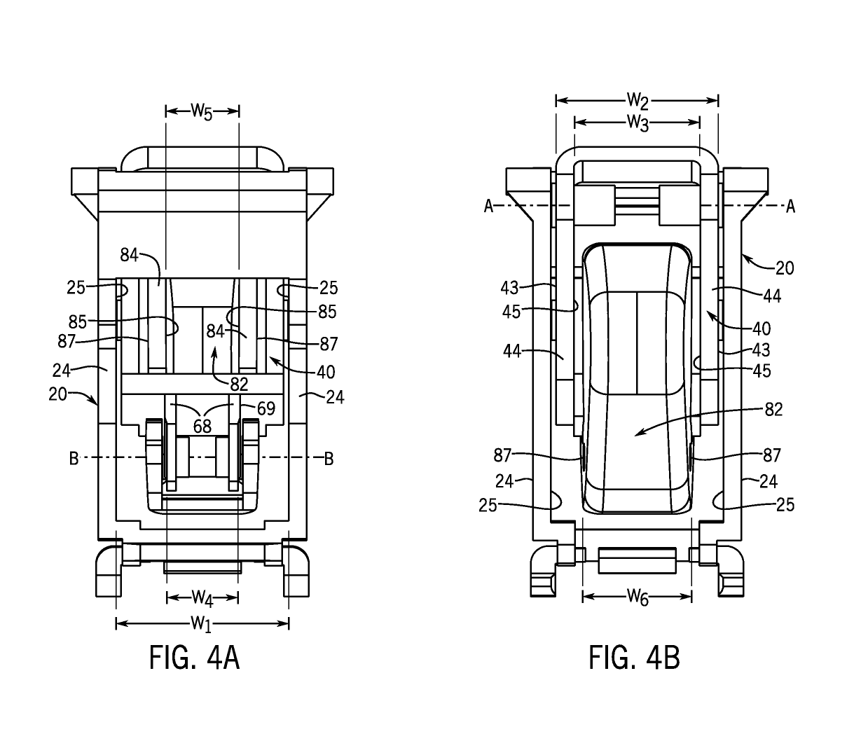

Each of the housing walls 24 includes an opening 36 defined in the inner surface 25 proximate the upper end 21 of the housing 20. For example, the opening 36 may be defined proximate the upper guide 30. As shown in FIG. 4B, an upper (i.e., first, arm, etc.) axis A-A extends between the openings 36. The inner surface 25 further defines an arcuate stopper slot 38 having a radius defined about the upper axis A-A. FIG. 3 shows the stopper slot 38 extending fully through the housing wall 24, although according to other exemplary embodiments, the stopper slot 38 may extend only partially through the housing wall 24.

Still referring to FIGS. 3-5, the arm 40 is shown according to an exemplary embodiment. The arm 40 includes a pair of opposing arm walls 44 (i.e., sides) extending generally vertically. The arm walls 44 include outer surfaces 43 defining an outer arm width W₂ therebetween. The outer arm width W₂ may be less than or substantially the same as the inner housing width W₁, such that the arm 40 may be received between the housing walls 24. The arm walls 44 further include inner arm surfaces 45 defining an inner arm width W₃ therebetween. An arm upper cross member 46 extends between the arm walls 44 proximate an upper end 41 of the arm 40 and an arm lower cross member 48 extend between the arm walls 44 proximate a lower end 42 of the arm 40.

An upper pin 50 extends generally outward from each of the arm walls 44 proximate the upper end 41 of the arm 40. The upper pin 50 may be generally cylindrical and is configured to be received in the opening 36 in the housing wall 24, such that the arm 40 is pivotally coupled to the housing 20 about the upper axis A-A. The upper pin 50 and the opening 36 interact to define an upper hinge rotating about the upper axis A-A. A stopper pin 52 extends generally outward from each of the arm walls 44 offset from and parallel to the upper pin 50. The stopper pin 52 may be offset from the upper pin 50 by a distance substantially the same as the radius defined by the stopper slot 38, such that when the upper pin 50 is received in the opening 36, the stopper pin 52 may be received in the stopper slot 38.

The retainer assembly 18 further includes an upper (i.e., first) spring 60. The upper spring 60 may be a torsion spring having a first tang 62, a second tang 64, and a coil 66 extending therebetween. According to an exemplary embodiment, an upper spring projection 54 extends inward from the inner surface 45 of each of the arm walls 44 coaxially with the upper pin 50. The upper spring projection 54 defines an outer diameter that is less than or substantially the same as an inner diameter of the coil 66, such that the upper spring 60 may be coupled to the arm 40 by receiving the upper spring projections 54 within the coil 66. For example, to couple the upper spring 60 to the arm 40, an installer may compress the coil 66, bringing the first tang 62 and the second tang 64 (e.g., defining lateral ends of the upper spring 60) closer together. The upper spring 60 may define a laterally compressed width less than a space between the upper spring projections 54. When the upper spring 60 is released, the coil 66 expands (i.e., rebounds) laterally outward until the coil 66 is disposed about each of the upper spring projections 54.

When the arm 40 is received in and coupled to the housing 20, the first tang 62 of the upper spring 60 engages a forward (i.e., inner, lower, etc.) surface 27 of the housing upper cross member 26 and the second tang 64 engages an arm wall 44. According to other exemplary embodiments, the first tang 62 may engage other surface of the housing 20 and the second tang 64 may engage other surfaces of the arm 40, for example a forward (i.e., inner, lower, etc.) surface 47 of the arm upper cross member 46. The stopper slot 38 defines a first (i.e., forward) end 37 and a second (i.e., rearward) end 39. In this configuration, the interaction between the stopper pin 52 and the stopper slot 38 limits (i.e., restricts) an angle of rotation of the arm 40 about the upper axis A-A. When a beverage container is inserted into a cup holder 4 and engages the retainer assembly 18, the arm 40 rotates (i.e., pivots) about the upper axis A-A away from the forward edge 23 of the housing 20. As the arm 40 rotates in this direction, the stopper pin 52 travels through the stopper slot 38 away from the first end 37 and toward the second end 39. The arm 40 may be pivoted away from the forward edge 23 until the stopper pin engages the second end 39 of the stopper slot 38, at which point the second end 39 prevents the stopper pin 52 and therefore the arm 40 from pivoting any further away from the front edge 23. During rotation of the arm 40 in this direction, angular displacement within the coil 66 causes an increase in torque, providing a returning bias on the arm 40 to pivot toward the front edge 23 of the housing 20. When the beverage container no longer engages the retainer assembly 18, the upper spring 60 forces the arm 40 back toward the forward edge 23 of the housing 20 until the stopper pin 52 engages the first end 37 of the stopper slot 38. In this configuration, the upper spring 60 may still be angularly displaced from its resting position, providing a torque on the upper spring 60, such that the stopper pin 52 is held in position against the first end 37 until the retainer assembly 18 is engaged.

While FIGS. 2-5 show the upper pin 50 extending from the arm wall 44 and the housing wall 24 defining the opening 36, according to another exemplary embodiment, the upper pin 50 may extend generally inward from the housing wall 24 and may be received in the opening 36 defined by the arm wall 44. Similarly, while the stopper pin 52 is shown extending from the arm wall 44 and the housing wall 24 is shown defining the stopper slot 38, according to another exemplary embodiment, the stopper pin 52 may extend generally inward from the housing wall 24 and may be received in the stopper slot 38 defined by the arm wall 44. According to other exemplary embodiments, the arm 40 may be pivotally coupled to the housing 20 in other ways.

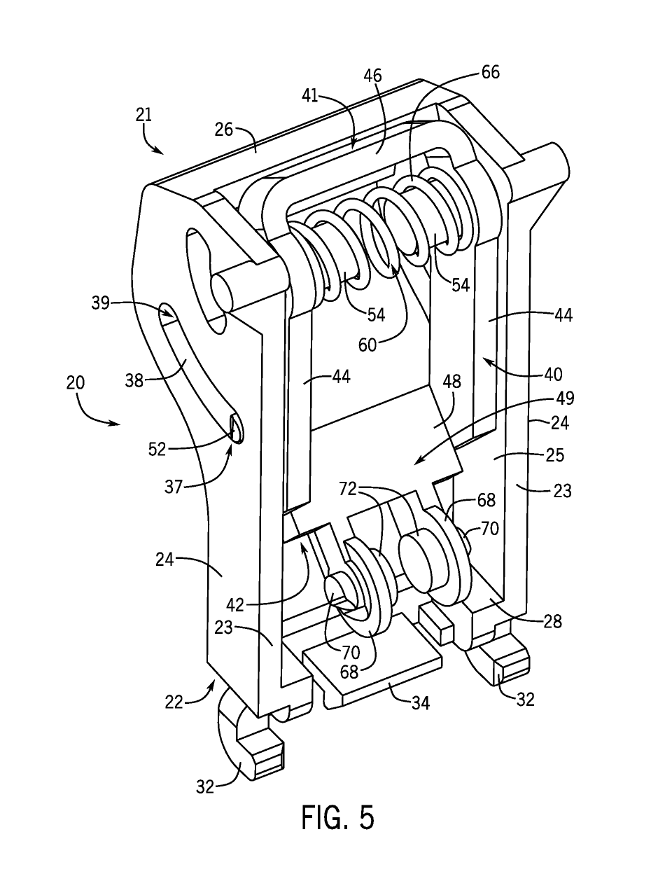

As shown in FIGS. 3 and 5, ends of the upper pin 50 and the stopper pin 52 define a chamfer or other angled surface. The chamfer is configured to reduce the distance that the housing walls 24 and/or the arm walls 44 must be deflected to receive the upper and stopper pins 50, 52 therebetween. For example, during assembly, the housing walls 24 may be deflected outward to an inner housing width Wᵢ wide enough to receive the chamfer portion of the upper and stopper pins 50, 52 but not to receive an outermost surface of the upper and stopper pins 50, 52. As the arm 40 is further inserted into the housing 20, the chamfer interacts with the inner surfaces 25 of the housing walls 24 to further deflect the housing walls 24 outward until the inner housing width W₁ is wide enough to receive the outermost surfaces of the upper and stopper pins 50, 52.

According to another exemplary embodiment, the arm walls 44 may be compressed toward each other for insertion into the housing 20. In this configuration, the outer arm width W₂ may be reduced until the chamfer portion of the upper and stopper pins 50, 52 are configured to be received between the housing walls 24. As the arm 40 is further inserted into the housing 20, the chamfer interacts with the inner surfaces 25 of the housing walls 24 to further deflect the arm walls 44 inward until the outer arm width W₂ is narrow enough for the housing walls 24 to receive the outermost surfaces of the upper and stopper pins 50, 52. The upper pins 50 are then aligned (e.g., axially) with the openings 36, along the upper axis A-A and the stopper pins 52 are aligned within the stopper slot 38, such that the housing walls 24 and/or the arm walls 44 are configured to rebound to their non-deflected positions. When the housing walls 24 and the arm walls 44 are in the non-deflected positions, the upper pins 50 are received in the openings 36 with an interference fit and the stopper pins are received in the stopper slots 38 with an interference fit. According to an exemplary embodiment, at least one of the housing 20 or the arm 40 is formed from a material capable of plastic deformation, such that the housing walls 24 and/or the arm walls 44 may be deflected for receiving the upper and stopper pins 50, 52 therebetween.

A set of opposing flanges 68 extend away from (e.g., below, coplanar with, etc.) the arm lower cross member 48. The flanges 68 include outer surfaces 69 defining an outer flange width W₄ therebetween. A lower pin 70 extends generally outward from each of the flanges 68 proximate the lower end 42 of the arm 40. As shown in FIG. 4A, the lower pin 70 may be generally cylindrical and a lower (i.e., second, finger, etc.) axis B-B may extend between the lower pins 70. A lower spring projection 72 extends inward from an inner surface 67 of each of the flanges 68 coaxially with the lower pin 70.

The retainer assembly 18 further includes a lower (i.e., second) spring 74. The lower spring 74 may be a torsion spring having a first tang 76, a second tang 78, and a coil 80 extending therebetween. The lower spring projection 72 defines an outer diameter that is less than or substantially the same as an inner diameter of the coil 80, such that the lower spring 74 may be coupled to the arm 40 by receiving the lower spring projections 72 within the coil 80. For example, to couple the lower spring 74 to the arm 40, an installer may compress the coil 80, bringing the first tang 76 and the second tang 78 (e.g., defining lateral ends of the lower spring 74) closer together. The lower spring 74 may define a laterally compressed width less than a space between the lower spring projections 72. When the lower spring 74 is released, the coil 80 expands (i.e., rebounds) laterally outward until the coil 80 is disposed about each of the spring projections 72.

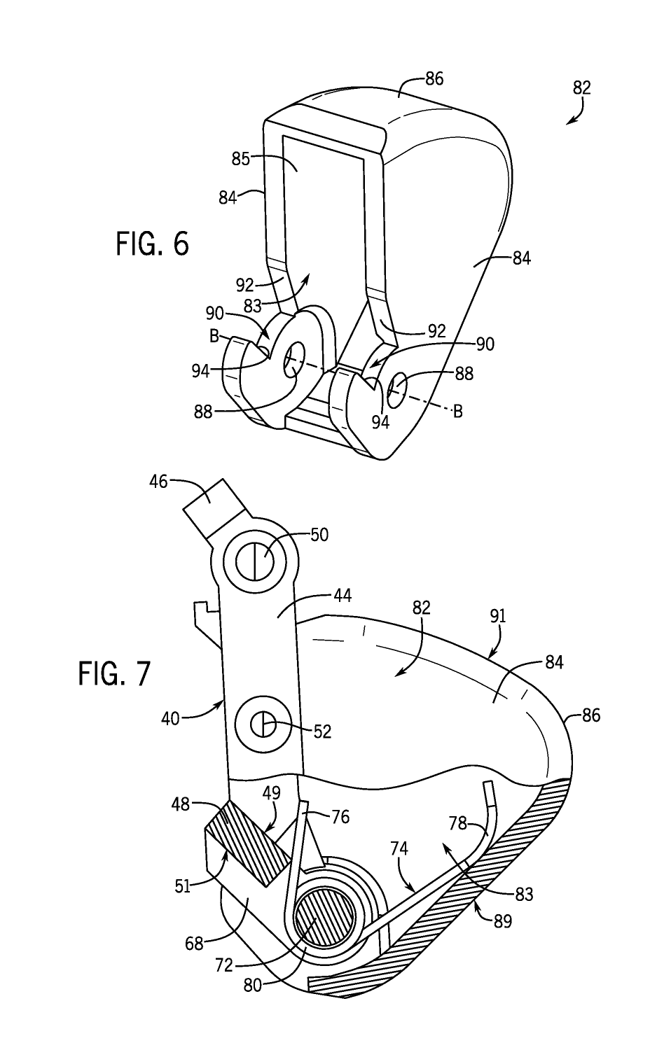

Referring to FIGS. 6, and 7, the retainer assembly 18 further includes the finger 82 configured to project through the slot 10 into the cup holder 4. The finger 82 includes opposing finger walls 84 (i.e., sides) defining a channel 83 (i.e., void, space, etc.) therebetween. At least a portion of an outer periphery of the finger walls 84 are connected by a shell 86 (e.g., web) extending therebetween to enclose the channel 83, such that the channel 83 is generally concealed from view within the cup holder 4. The outer periphery may define a generally rounded triangular shape defining a lower portion 89 and an upper portion 91 of the shell 86. The lower portion 89 may extend generally between a finger opening 88 and the upper portion 91. As shown in FIG. 4A, the finger walls 84 include inner surfaces 85 having an inner finger width W₅ defined therebetween. The inner finger width W₅ may be substantially the same as or greater than the outer flange width W₄, such that the finger 82 is configured to receive the flanges 68 therein. The finger walls 84 may further include outer surfaces 87 having an outer finger width W₆ defined therebetween. The outer finger width W₆ may be substantially the same as or less than the inner arm width W₃, such that the finger 82 may be received between the arm walls 44.

The finger openings 88 extend generally coaxially through each of the finger walls 84. The finger openings 88 are configured to receive the lower pins 70 therein, such that the finger openings 88 are disposed along the lower axis B-B. In this configuration, the finger 82 is pivotally coupled to the arm 40 about the lower axis B-B and the lower pin 70 and the finger opening 88 interact to define a lower hinge rotating about the lower axis B-B. While FIGS. 2-5 show the lower pin 70 extending from the flange 68 and the finger opening 88 defined in the finger 82, according to another exemplary embodiment, the lower pin 70 may extend generally inward from the finger wall 84 and may be received in the finger opening 88 defined by the flange 68. According to other exemplary embodiments, the finger 82 may be pivotally coupled to the arm 40 in other ways.

As shown in FIGS. 3 and 5, ends of the lower pin 70 define a chamfer or other angled surface substantially similar to the chamfer described above. The chamfer is configured to reduce the distance that the flanges 68 and/or the finger walls 84 must be deflected to receive the lower pins 70 therebetween. For example, during assembly, the finger walls 84 may be deflected outward to an inner finger width W₅ wide enough to receive the chamfer portion of the lower pins 70 but not to receive an outermost surface of the lower pins 70. As the flanges 68 are further inserted into the finger 82, the chamfer interacts with the inner surfaces 85 of the finger walls 84 to further deflect the finger walls 84 outward until the inner finger width W₅ is wide enough to receive the outermost surfaces of the lower pins 70.

According to another exemplary embodiment, the flanges 68 may be compressed toward each other for insertion into the finger 82. In this configuration, the outer flange width W₄ may be reduced until the chamfer portion of the lower pins 70 are configured to be received between the finger walls 84. As the flanges 68 are further inserted into the channel 83 of the finger 82, the chamfer interacts with the inner surfaces 85 of the finger walls 84 to further deflect the flanges 68 inward until the outer flange width W₄ is narrow enough for the finger walls 84 to receive the outermost surfaces of the lower pins 70. The lower pins 70 are then aligned (e.g., axially) with the finger openings 88, along the lower axis B-B, such that the finger walls 84 and/or the flanges 68 are configured to rebound to their non-deflected positions. When the finger walls 84 and the flanges 68 are in the non-deflected positions, the lower pins 70 are received in the finger openings 88 with an interference fit. According to an exemplary embodiment, at least one of the arm 40 or the finger 82 is formed from a material capable of plastic deformation, such that the arm walls 44 and/or the finger walls 80 may be deflected for receiving the lower pins 70 therebetween.

Referring now to FIG. 7, the lower spring 74 is shown according to an exemplary embodiment. When the finger 82 is received in and coupled to the arm 40, the first tang 76 of the lower spring 74 engages the arm lower cross member 48. For example, the first tang 76 may engage a forward (i.e., inner, upper, first, etc.) surface 49 of the arm lower cross member 48. According to other exemplary embodiments, the first tang 76 may engage other surfaces of the arm 40, for example, a rearward (i.e., outer, lower, second, etc.) surface 51 of the arm lower cross member 48, defining an opposing side of the arm lower cross member 48 from the forward surface 49. The second tang 78 extends into the channel 83 of the finger 82 and engages the shell 86 therein, although according to other exemplary embodiments, the second tang 78 may engage other surfaces of the finger 82.

Each of the finger walls 84 defines an arcuate notch 90 formed between a first (i.e., forward) notch end 92 and a second (i.e., rearward) notch end 94. For example, the notch 90 may be defined generally radially about the finger opening 88. The finger 82 is configured to receive the arm lower cross member 48 at least partially within the notch 90 and to rotate (i.e., pivot) about the lower axis B-B with the arm lower cross member 48 disposed within the notch 90. In this configuration, the interaction between the notch 90 and the arm lower cross member 48 limits (i.e., restricts) an angle of rotation of the finger 82 about the lower axis B-B. When a beverage container is removed from a cup holder 4 and engages the retainer assembly 18, the finger 82 rotates about the lower axis B-B, such that the finger 82 is further received within the arm 40. As the finger 82 rotates in this direction, the first notch end 92 pivots toward the forward surface 49 of the arm lower cross member 48 and the second notch end 94 pivots away from the rearward surface 51. The finger 82 may be further rotated until the first notch end 92 engages the forward surface 49, at which point the forward surface 49 prevents the finger 82 from further rotating. After complete rotation of the finger 82 until the first notch end 92 engages the arm lower cross member 48, the arm 40 may rotate about the upper axis A-A to further withdraw the finger 82 through the slot 10 and out of the cup holder 4. During rotation of the finger 82 in this direction, angular displacement within the coil 80 causes an increase in torque, providing a returning bias on the finger 82 to pivot away from the arm 40 and into the cup holder 4. When the beverage container no longer engages the retainer assembly 18, the lower spring 74 forces the finger 82 away from the arm 40 until the second notch end 94 engages the rearward surface 51 of the arm lower cross member 48. In this configuration, the lower spring 74 may still be angularly displaced from its resting position, providing a torque on the lower spring 74, such that the second notch end 94 is held in position against the rearward surface 51 until the retention assembly 18 is engaged.

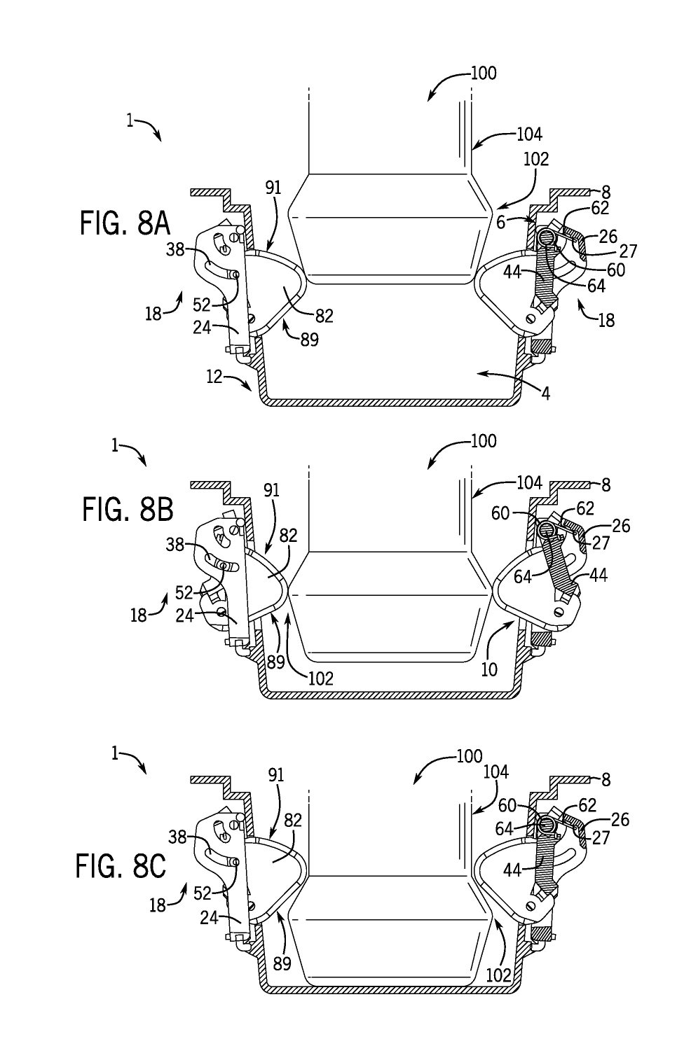

Referring now to FIGS. 8A-8C, the insertion of a beverage container 100 into the cup holder 4 is shown according to an exemplary embodiment. The retainer assembly 18 shown on the right side of the cup holder 4 is a cut away view of the retainer assembly 18, with a housing wall 24 and an arm wall 44 cut away to show the movement of the arm 40 within the housing 20.

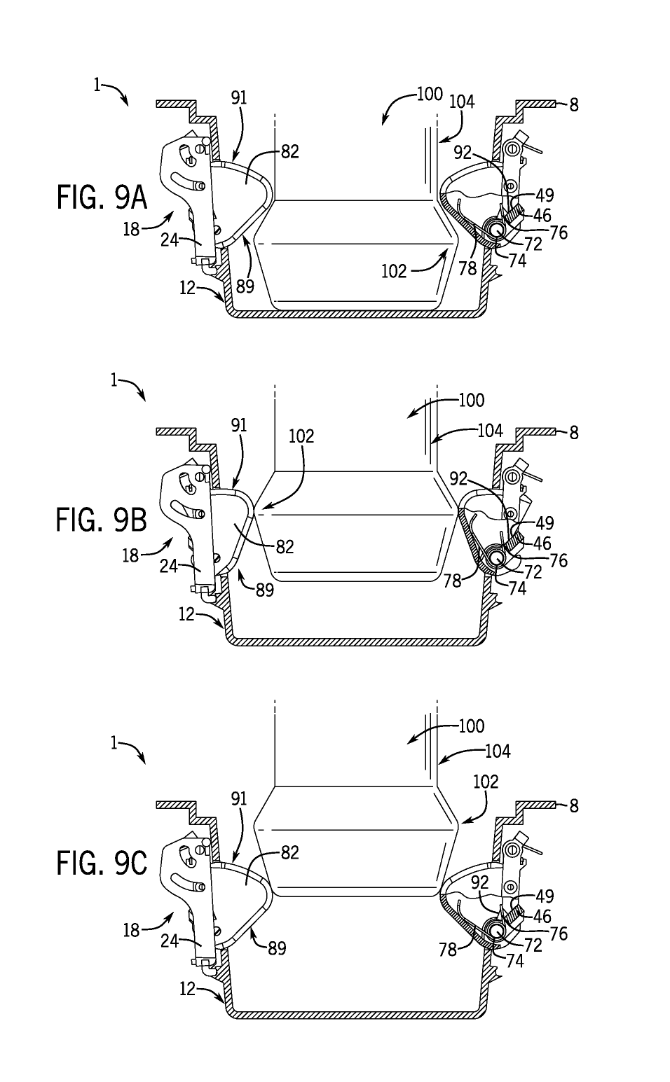

The container 100 defines a generally convex lower portion 102 configured to be received below the retainer assemblies 18 and a generally concave middle portion 104 configured to be received proximate the fingers 82 when the container 100 is fully received in the cup holder 4. The lower portion 102 defines a lower portion diameter and the middle portion 104 defines a middle portion diameter less than the lower portion diameter. While FIGS. 8A-9C show the cup holder 4 receiving the container 100 therein, according to other exemplary embodiments, the cup holder 4 may be configured to receive other objects (e.g., a phone, a GPS, etc.) therein having similar or different shapes as the container 100.

Referring to FIG. 8A, the lower portion 102 of the container is disposed above and disengaged from the fingers 82 of the retainer assemblies 18. In this position, the upper spring 60 and the lower spring 74 are in the non-deflected positions defined above. As discussed above, the stopper pin 52 engages the first end 37 of the stopper slot 38, preventing the arm 40 and the finger 82 from extending further into the cup holder 4. According to an exemplary embodiment, the slot 10 is sized large enough (e.g., in height and width) to receive the finger 82 therethrough, but not large enough to receive the arm 40 therethrough. In this configuration, when the arm 40 is disposed in a forwardmost position (e.g., the stopper pin 52 engages the first end 37 of the stopper slot 38), the arm 40 is disposed proximate and/or engages the outer surface 12 of the cup holder 4.

As shown in FIG. 8B, as the container 100 is further inserted into the cup holder 4, the lower portion 102 engages the upper portion 89 of the shell 86 of the fingers 82 or other surface of the fingers 82, pushing the fingers 82 through the slots 10 laterally outward from the cup holder 4. When the lower portion 102 engages the finger 82, the arm 40 may pivot relative to the housing 20 about upper axis A-A. The finger 82 may remain in a fixed orientation relative to the arm 40, such that only the upper spring 60 deflects while the lower spring 74 remains in the non-deflected position. For example, FIG. 8B shows the second tang 64 rotating about the upper axis A-A toward the first tang 62, thereby compressing the coil 66 therebetween. According to another exemplary embodiment, the finger 82 may pivot relative to the arm 40 about lower axis B-B in addition to the pivot of the arm 40.

Referring to FIG. 8C, the lower portion 102 is shown received below the fingers 82, such that the middle portion 104 is disposed proximate the fingers 82. Where the middle portion diameter is less than or substantially the same as a distance between opposing fingers 82 in the non-deflected position (e.g., as shown in FIG. 8A), the arm 40 may return to its fully non-deflected position. In this configuration, the container 100 may not engage any of the fingers 82 or may engage fewer than all of the fingers 82. The container 100 may be subject to external loads from a vehicle occupant or the vehicle itself moving, such that the container 100 may move within the cup holder 4. For example, the container 100 may move laterally within the cup holder 4 or may tilt about the lower portion 102. As the container 100 moves in these ways, the middle portion 104 may come into engagement with more or fewer fingers 82. According to another exemplary embodiment, the middle portion diameter may be greater than a distance between opposing fingers 82 in the non-deflected position. In this configuration, one or both of the arm 40 and the finger 82 may be in a pivoted position while the container 100 is fully received in the cup holder 4, such that the corresponding upper spring 60 and/or lower spring 74 remain in a partially deflected position when the container 100 is fully received in the cup holder 4.

Referring now to FIGS. 9A-9C, the withdrawal or removal of the container 100 from the cup holder 4 is shown according to an exemplary embodiment. The retainer assembly 18 shown on the right side of the cup holder 4 is a cut away view of the retainer assembly 18, with a housing wall 24, an arm wall 44, and a portion of a finger wall 84 cut away to show the movement of the finger 82 within the arm 40.

Referring to FIG. 9A, container 100 is fully received in the cup holder 4 (e.g., as shown in FIG. 8C), such that the lower portion 102 is disposed generally below the fingers 82 and the middle portion 104 is disposed proximate the fingers 82. As shown in FIG. 9B, as the container 100 is withdrawn from the cup holder 4, the lower portion 102 engages the lower portion 91 of the shell 86 of the fingers 82 or other portions of the fingers 82, pivoting the fingers 82 outward through the slots 10. When the lower portion 102 engages the finger 82, the finger 82 may pivot relative to the arm 40 about the lower axis B-B. The arm 40 may remain in a fixed orientation relative to the housing 20, such that only the lower spring 74 deflects while the upper spring 60 remains in the non-deflected position. For example, FIG. 9B shows the second tang 78 rotating about the lower axis B-B toward the first tang 76, thereby compressing the coil 80 therebetween. According to another exemplary embodiment, the arm 40 may pivot relative to the housing 20 about upper axis A-A in addition to the pivot of the finger 82.

Referring to FIG. 9C, the container 100 is shown fully withdrawn from the cup holder 4. In this configuration, the retainer assemblies 18 return to the fully non-deflected positions as described in FIG. 8A.

For purposes of this application, the terms “front,” “forward,” and the like refer to a side or direction in the retainer assembly 18 toward the outer surface 12 of the walls 6 of the cup holder 4. The terms “rear,” “rearward,” and the like refer to a side or direction in the retainer assembly 18 away from the outer surface 12. According to other exemplary embodiments, the retainer assembly 18 may have other orientations relative to the wall 6 of the cup holder 4. Thus, while the description has used terms such as “upper” and “lower” to describe various components, it should be understood that the orientation of the various components may be varied according to other exemplary embodiments.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of this disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the position of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is to be understood that although the present invention has been described with regard to preferred embodiments thereof, various other embodiments and variants may occur to those skilled in the art, which are within the scope and spirit of the invention, and such other embodiments and variants are intended to be covered by corresponding claims. Those skilled in the art will readily appreciate that many modifications are possible (e.g., variations in sizes, structures, shapes and proportions of the various elements, mounting arrangements, use of materials, orientations, etc.) without materially departing from the novel teachings and advantages of the subject matter described herein. For example, the order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed is:

1. A retainer assembly for a cup holder, comprising:
an arm defining an first axis and a second axis, the arm configured to pivot about the first axis; and
a finger pivotally coupled to the arm about the second axis;
wherein the finger is configured to be received in the cup holder.

2. The retainer assembly according to claim 1, further comprising a spring having a first tang, a second tang, and a coil extending therebetween;
wherein the first tang is configured to engage the arm; and
wherein the second tang is configured to engage the finger.

3. The retainer assembly according to claim 2, wherein the spring is configured to bias the finger into the cup holder.

4. The retainer assembly according to claim 1, wherein the arm further comprises a cross member;
wherein the finger defines a notch configured to receive the cross member therein; and
wherein the notch is configured to restrict an angle of rotation of the arm about the first axis.

5. The retainer assembly according to claim 4, wherein a rearward end of the notch is configured to engage the cross member when the finger is not engaged within the cup holder.

6. The retainer assembly according to claim 1, further comprising a housing;
wherein the arm is configured to pivot relative to the housing, about the first axis.

7. The retainer assembly according to claim 6, further comprising a spring having a first tang, a second tang, and a coil extending therebetween;
wherein the first tang is configured to engage the housing; and
wherein the second tang is configured to engage the arm.

8. The retainer assembly according to claim 7, wherein the spring is configured to bias the arm toward the cup holder.

9. The retainer assembly according to claim 7, further comprising a stopper pin extending outwardly from one of the arm or the housing; and
a stopper slot defined in the other of the arm or the housing;
wherein the stopper pin is configured to be received in the stopper slot; and
wherein the stopper slot is configured to restrict an angle of rotation of the arm about the first axis.

10. The retainer assembly according to claim 9, wherein the stopper pin is configured to engage a first end of the stopper slot when the retainer assembly is not engaged within the cup holder.

11. A cup holder assembly, comprising:
a cup holder;
a retainer assembly comprising:
an arm defining an upper axis and a lower axis, the arm configured to pivot about the upper axis; and
a finger pivotally coupled to the arm about the lower axis;
wherein the finger is configured to be received in the cup holder.

12. The cup holder assembly according to claim 11, wherein the arm is pivotally coupled to the cup holder through the upper axis.

13. The cup holder assembly according to claim 11, wherein the finger defines a notch configured to restrict rotation of the finger about the lower axis.

14. The cup holder assembly according to claim 11, wherein the retainer assembly further comprises a housing having a stopper slot;
wherein the arm further comprises a stopper pin extending outward therefrom, the stopper configured to be received in the stopper slot.

15. The cup holder assembly according to claim 11, wherein the cup holder further comprises a wall and an elongate slot extending therethrough; and
wherein the slot is configured to receive the finger therethrough.

16. The cup holder assembly according to claim 15, wherein the retainer assembly is coupled to the wall at an outer surface thereof.

17. The cup holder assembly according to claim 15, further comprising a plurality of retainer assemblies, each retainer assembly configured to extend through a corresponding slot.

18. The cup holder assembly according to claim 11, wherein the arm is configured to pivot about the upper axis as an object is received in the cup holder, such that the object engages the finger.

19. The cup holder assembly according to claim 18, wherein the finger is configured to pivot about the lower axis as the object is withdrawn from the cup holder.

20. The cup holder assembly according to claim 19, wherein the finger defines an outer periphery having an upper portion and a lower portion;
wherein the upper portion is configured to engage the object as the object is received in the cup holder; and
wherein the lower portion is configured to engage the object as the object is withdrawn from the cup holder.
